(19) United States
(12) Patent Application Publication
(10) Pub. No.: US 2026/0228152 A1
(43) Pub. Date: Aug. 6, 2026

(54) EXTENDING A DIRECT ELECTRICAL UNIVERSAL SERIAL BUS (USB) TYPE-C CONNECTION TO VEHICLE DIAGNOSTIC CONNECTIONS

(71) Applicant: GEOMETRIS LP, Houston, TX (US)

(72) Inventors: Manish Jagdish Desai, Cypress, TX (US); Narayan Manish Desai, Houston, TX (US); Celso Dario Siado, Houston, TX (US); Bipin Kadel, Katy, TX (US)

(21) Appl. No.: 19/466,669

(22) Filed: Feb. 2, 2026

Related U.S. Application Data
(60) Provisional application No. 63/753,180, filed on Feb. 3, 2025.

(51) Int. Cl. G06F 13/38; G06F 13/42

(52) U.S. Cl. CPC G06F 13/382; G06F 13/4282; G06F 2213/0042

(57) ABSTRACT

A physical device includes: a cable; an on-board diagnostics (OBD) part, in which the OBD part is operatively connected to a vehicle device of a vehicle via an OBD port of the vehicle; and a universal serial bus (USB) type C (USB-C) part, in which the USB-C part is operatively connected to the OBD part via the cable, in which an end device is operatively connected to the USB-C part via a USB-C port of the end device, in which the end device is operatively connected to the vehicle device via the physical device to receive and process vehicle related information (VRI) without requiring an intermediate computing device or a printed circuit board (PCB) in between the end device and the vehicle device, and in which the end device comprises only one PCB to receive and process the VRI.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the invention.

FIG. 1.1 shows a diagram of a system in accordance with one or more embodiments disclosed herein.

FIG. 1.2 shows a diagram of a vehicle in accordance with one or more embodiments disclosed herein.

FIG. 1.3 shows a first isometric view of an on-board diagnostics (OBD) part/side/connector of a physical component/device in accordance with one or more embodiments disclosed herein.

FIG. 1.4 shows a second isometric view of the OBD part of the physical component in accordance with one or more embodiments disclosed herein.

FIG. 1.5 shows a third isometric view of the OBD part of the physical component in accordance with one or more embodiments disclosed herein.

FIG. 1.6 shows a fourth isometric view of the OBD part of the physical component in accordance with one or more embodiments disclosed herein.

FIG. 1.7 shows a fifth isometric view of the OBD part of the physical component in accordance with one or more embodiments disclosed herein.

FIG. 1.8 shows a sixth isometric view of the OBD part of the physical component in accordance with one or more embodiments disclosed herein.

FIG. 1.9 shows a first side view of the OBD part of the physical component in accordance with one or more embodiments disclosed herein.

FIG. 1.10 shows a top view of the OBD part of the physical component in accordance with one or more embodiments disclosed herein.

FIG. 1.11 shows a second side view of the OBD part of the physical component in accordance with one or more embodiments disclosed herein.

FIG. 1.12 shows a third side view of the OBD part of the physical component in accordance with one or more embodiments disclosed herein.

FIG. 2.1 shows a first isometric view of a USB Type C (USB-C) part/side of the physical component in accordance with one or more embodiments disclosed herein.

FIG. 2.2 shows a second isometric view of the USB-C part of the physical component in accordance with one or more embodiments disclosed herein.

FIG. 2.3 shows a side view of the USB-C part of the physical component in accordance with one or more embodiments disclosed herein.

FIG. 2.4 shows a rear view of the USB-C part of the physical component in accordance with one or more embodiments disclosed herein.

FIG. 2.5 shows a front view of the USB-C part of the physical component in accordance with one or more embodiments disclosed herein.

FIG. 2.6 shows an example USB-C plug connector of the USB-C part of the physical component in accordance with one or more embodiments disclosed herein.

FIG. 3 shows a front view of the second part of the OBD connector in accordance with one or more embodiments disclosed herein.

FIG. 4 shows a method for monitoring a vehicle in accordance with one or more embodiments disclosed herein.

FIG. 5 shows a diagram of a computing device in accordance with one or more embodiments disclosed herein.

### DETAILED DESCRIPTION

In general, conventional/traditional solutions connecting vehicle data interfaces (e.g., vehicle data information (VDI) buses) to electrical USB-C connections have one or more intermediate computing devices (that varies for each vehicle type) and/or printed circuit boards (PCBs) in between a corresponding physical vehicle connection and a related computing device (e.g., a related end device such as a camera that is adapted to obtain optical information regarding a scene/environment, a telematics device, etc.) to, at least, determine which protocol should be implemented and to perform/provide signal conditioning, signal translation, data processing, and power management capabilities. This results in an expensive system that requires complex implementation, which may cause multiple points of failure during operation.

For at least the reasons discussed above and without requiring resource-intensive efforts (e.g., time, engineering, utilization of excessive computing resources, etc.), a fundamentally different approach/framework is needed (e.g., a physical component/device that concentrates vehicle data interface connections and electric power connections/channels directly to a corresponding end device, without the need for any intermediate computing device and/or PCB to perform, at least, the aforementioned functionalities).

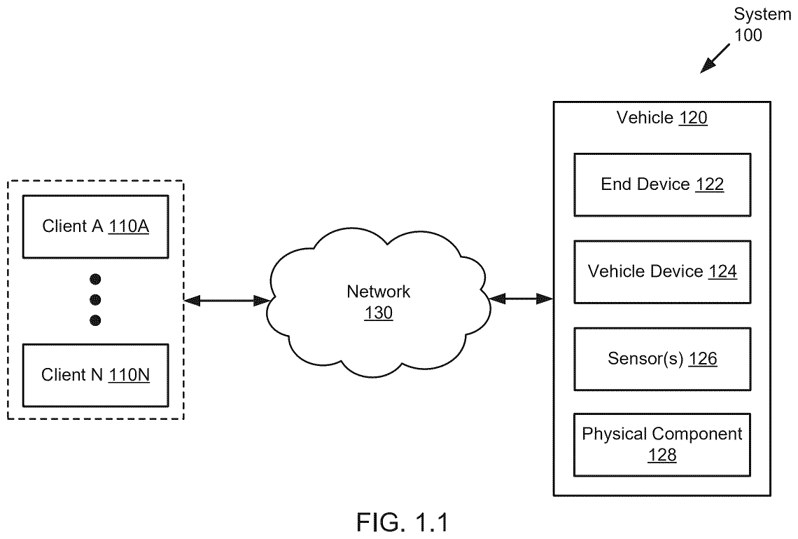

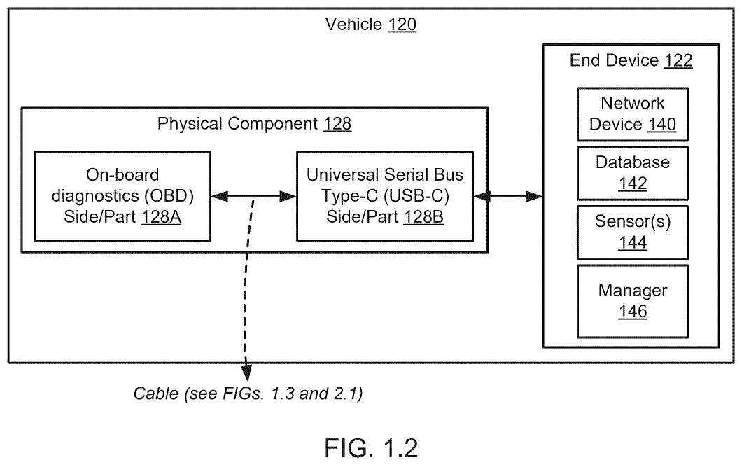

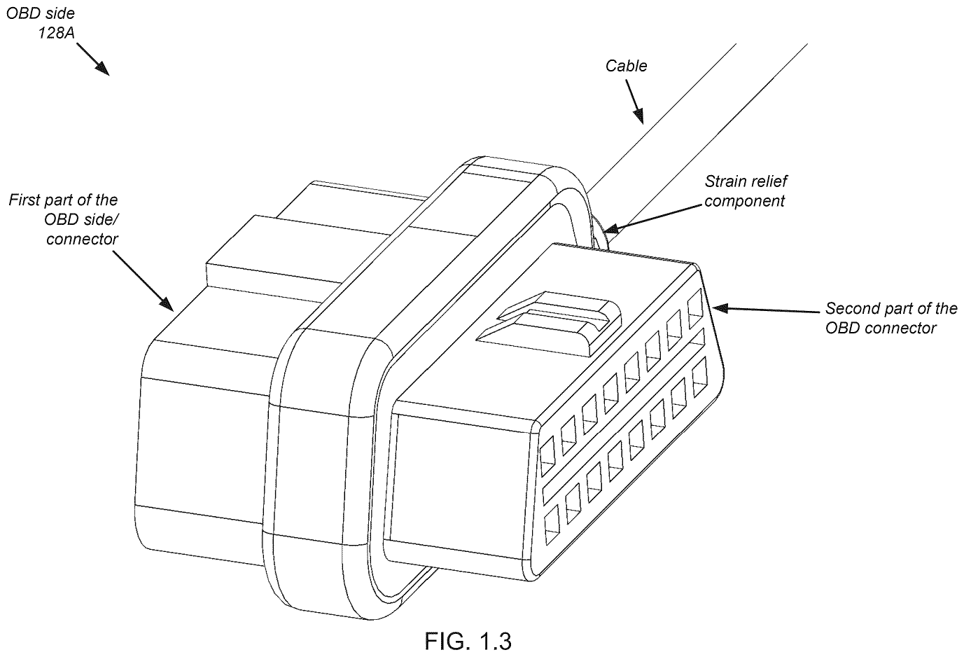

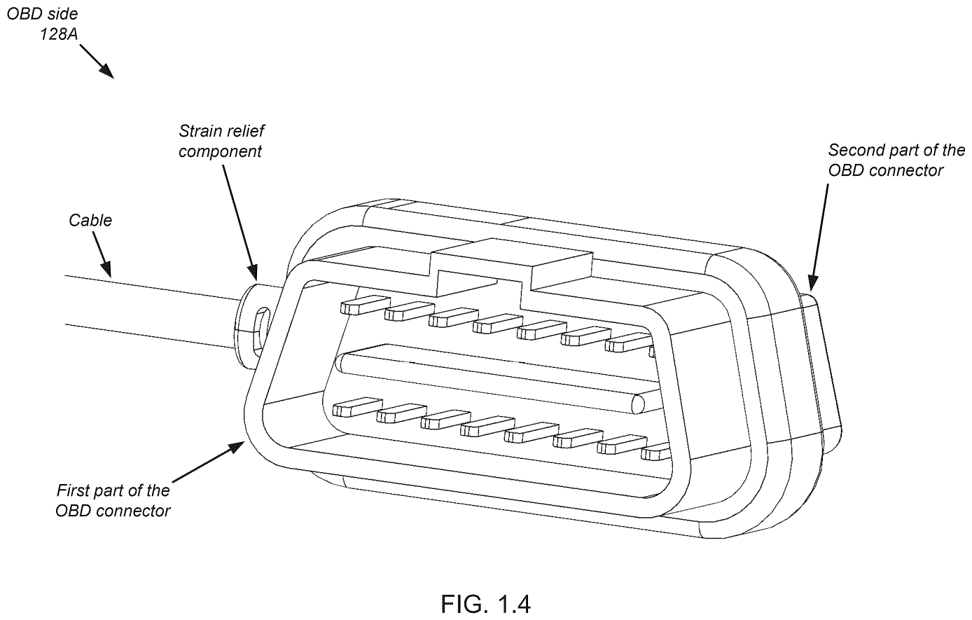

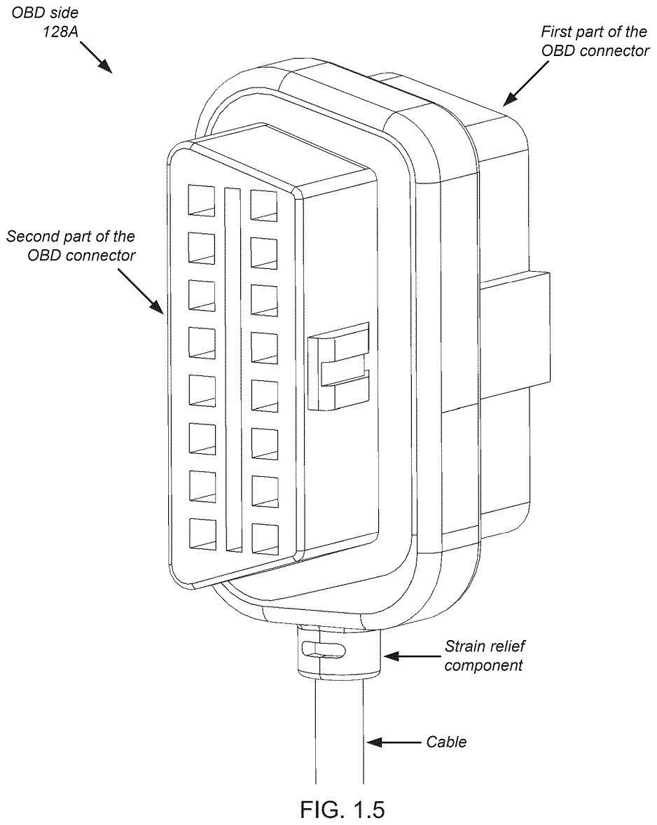

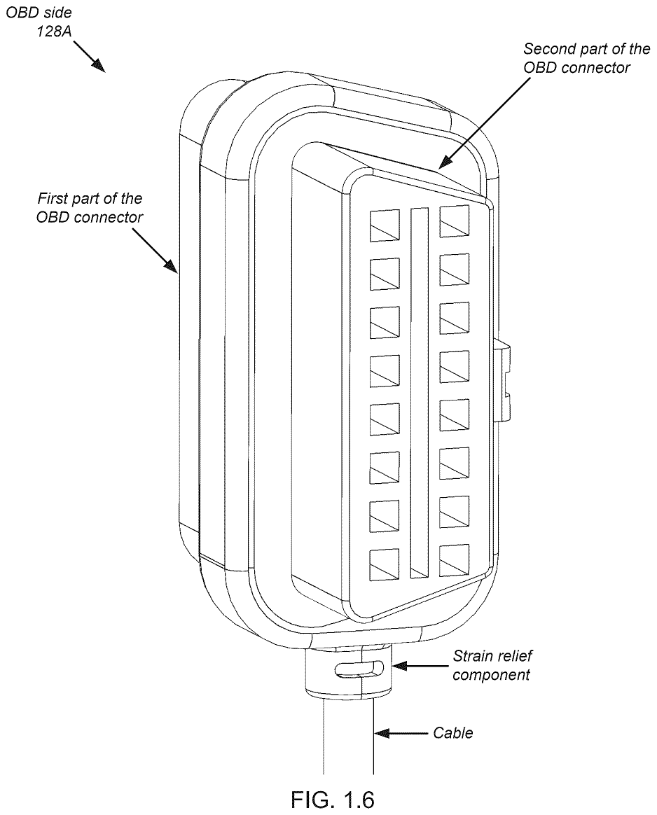

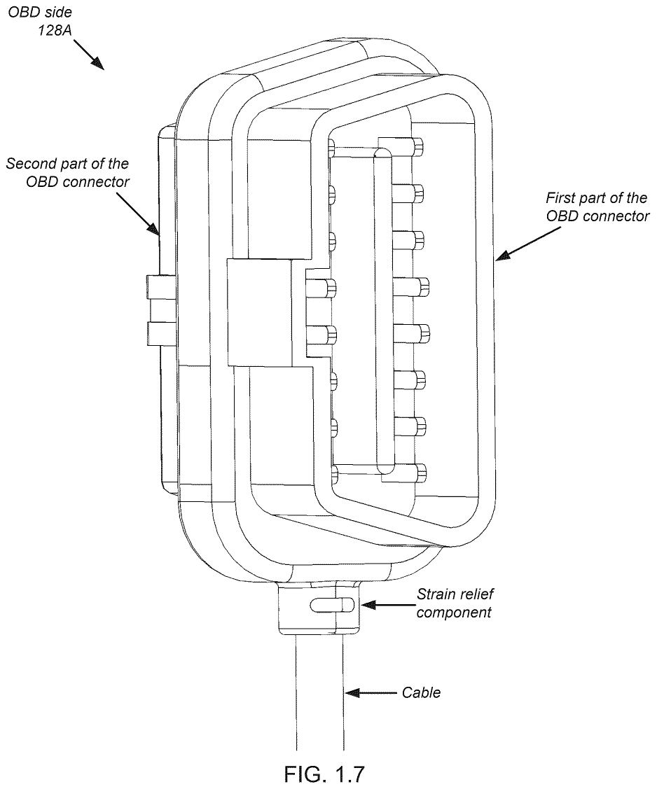

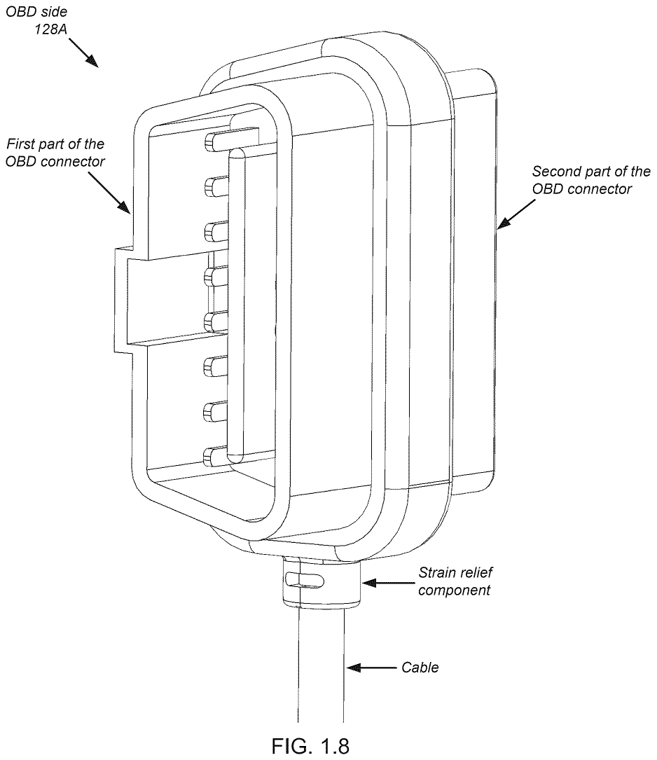

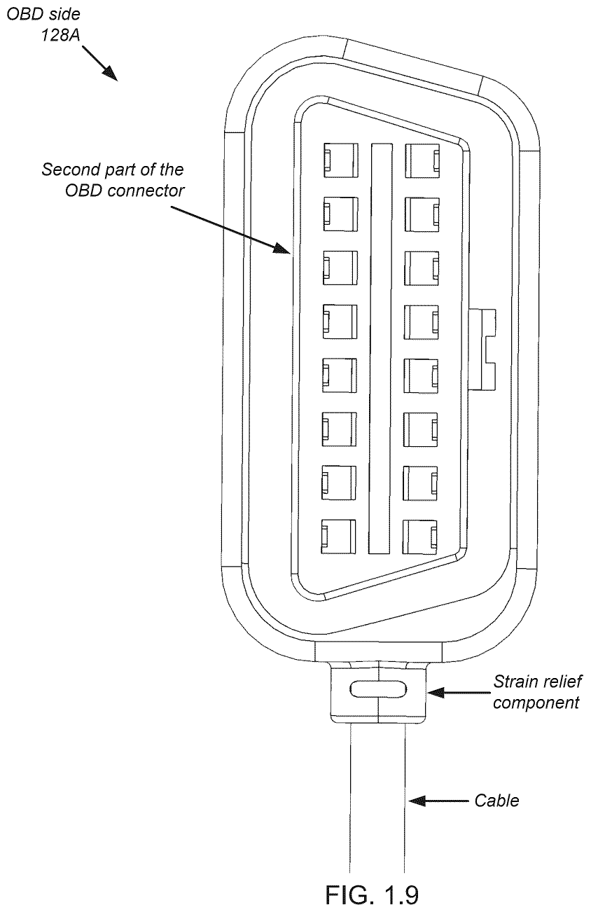

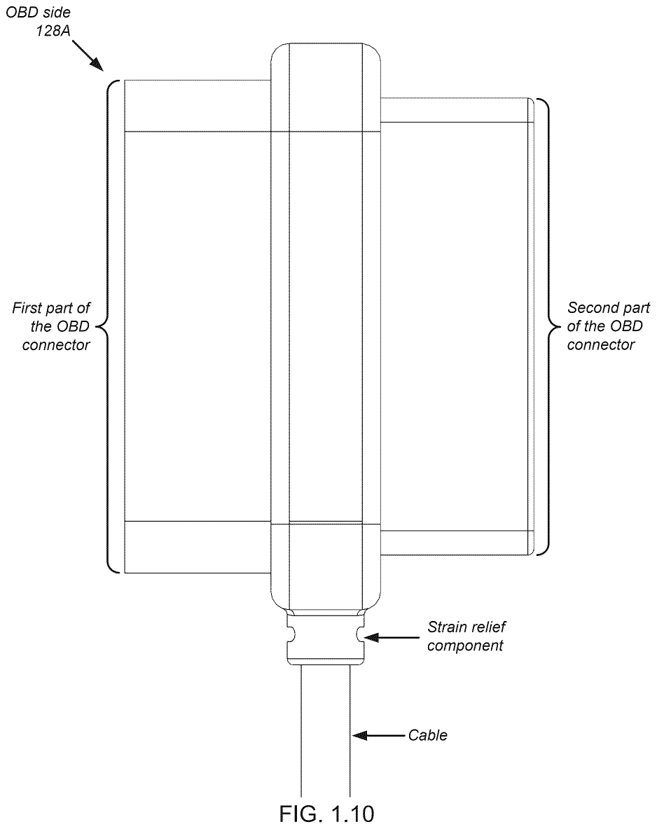

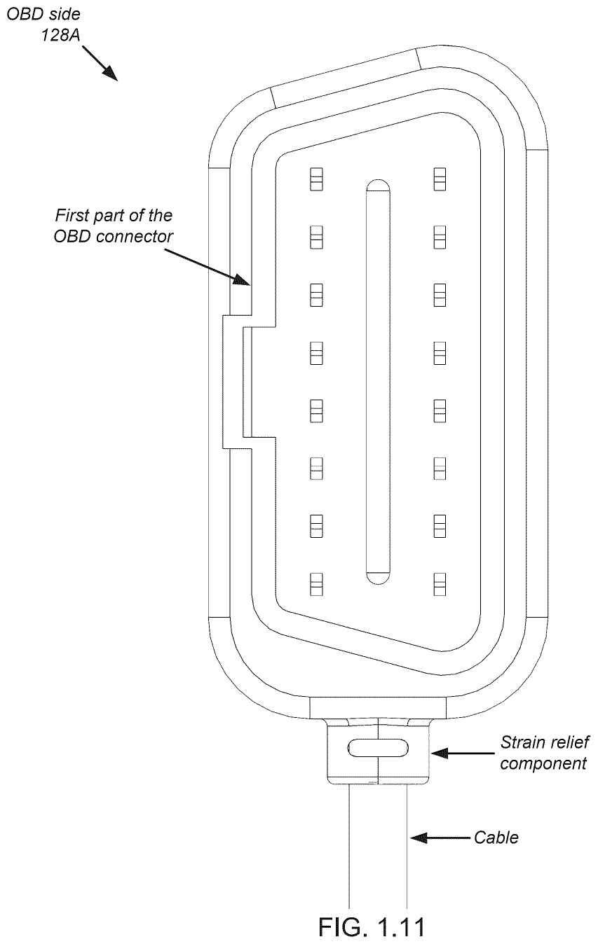

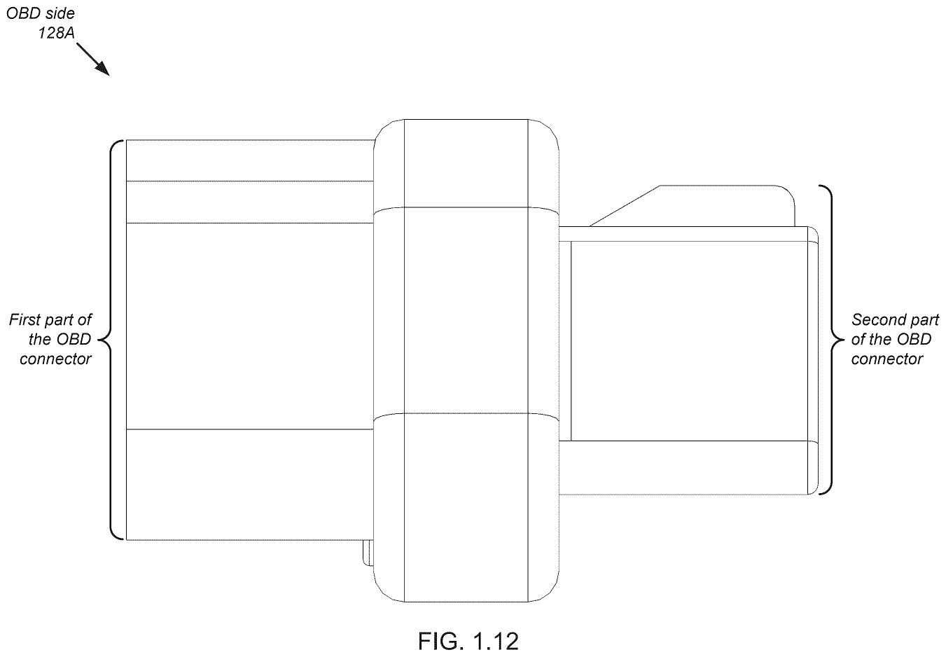

Embodiments disclosed herein relate to a computing device that extends a direct electrical USB-C connection to vehicle diagnostic connections (e.g., OBD related connections/channels) for integrating and transmitting data across various VDI buses. As a result of the processes discussed below, one or more embodiments disclosed herein advantageously ensure that: (i) the framework (e.g., 128, FIG. 1.1) connects/concentrates vehicle data interfaces “directly” on/to a related end device via electrical USB-C connections, without the need for any intermediate computing device and/or PCB (e.g., to determine which protocol should be implemented, to perform/provide signal conditioning, signal translation, data processing, and power protection and management capabilities, etc.); (ii) the framework provides a much simpler, generic, less expensive, and more reliable system implementation that improves user/customer experience/satisfaction and minimizes multiple points of failure during operation (that may be caused by the noisy electrical environment (e.g., an environment that generates load dumps, transient voltage spikes, etc.) that a corresponding user vehicle is located); (iii) the framework can operate (or provide its aforementioned functionalities) without having prior knowledge of its installation environment (e.g., without requiring preinstallation information with respect to a vehicle and/or an end device (e.g., a dash or windshield mounted camera device) that the framework would be connected to (or is installed)); (iv) through its USB-C side/part (e.g., through its USB-C plug connector), the framework can be used as a general purpose USB-C device (said another way, the framework is safely interoperable with any USB-C cable with restricted features or full features enabled via the USB-C plug connector); (v) through its USB-C side/part, the framework is compliant (and safely interoperable) with any computing device (as the end device) that support a USB-C connection (without damaging the related computing device); and/or (vi) comparing to conventional solutions (which provide less data processing functionality/capability via a corresponding intermediate computing device), the framework provides more data processing functionality (which requires more computing resource consumption) by performing the data processing at the end device (not at the intermediate computing device).

The following describes various embodiments disclosed herein.

FIG. 1.1 shows a diagram of a system (100) in accordance with one or more embodiments disclosed herein. The system (100) includes any number of clients (e.g., Client A (110A), Client N (110N), etc.), a network (130), and a vehicle (120) that includes an end device (122), a vehicle device (124), a set of sensors (126), and a physical component (128). The system (100) may include additional, fewer, and/or different components without departing from the scope of the embodiments disclosed herein. Each component may be operably/operatively connected to any of the other components via any combination of wired and/or wireless connections. Each component illustrated in FIG. 1.1 is discussed below.

In one or more embodiments, the clients (e.g., 110A, 110N, etc.), the network (130), the end device (122), the vehicle device (124), the set of sensors (126), and the physical component (128) may be (or may include) physical hardware or logical devices, as discussed below. While FIG. 1.1 shows a specific configuration of the system (100), other configurations may be used without departing from the scope of the embodiments disclosed herein. For example, although the clients (e.g., 110A, 110N, etc.) and the vehicle (120) are shown to be operatively connected through a communication network (e.g., 130), the clients (e.g., 110A, 110N, etc.) and the vehicle (120) may be directly connected (e.g., without an intervening communication network).

Further, the functioning of the clients (e.g., 110A, 110N, etc.) and the vehicle (120) is not dependent upon the functioning and/or existence of the other components (e.g., devices) in the system (100). Rather, the clients and the vehicle may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a virtual machine (VM) executing on a remote computing device, execution from a removable storage device connected to the client (such as a USB device), etc.

In one or more embodiments, the vehicle (120) may represent any vehicle that has any suitable unique identifier (e.g., an ISO 3779 vehicle identification number (VIN)). The vehicle (120) may be, for example, a motor vehicle such as a truck, a car, a van, a sports utility vehicle, or any other motor vehicle. To that end, the vehicle (120) is capable of moving under its own power, the movement of which may be controlled by an operator/user.

In one or more embodiments, the vehicle (120) may include the set of sensors (126). A sensor of the set of sensors (126) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the clients (e.g., 110A, 110N, etc.)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the sensor may perform other functionalities without departing from the scope of the embodiments disclosed herein.

In one or more embodiments, sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

For example, a sensor of the set of sensors (126) may collect data representative of the movement of the vehicle (120) including speed and acceleration along with the direction of the movement. In this example, the sensor may include speedometers, accelerometers, gyroscopes, magnetometers, geolocation devices (e.g., a device that provides global positions (i.e., latitude and longitude coordinates) using any of the global navigation satellite systems, or any other type of sensor operable to measure movement. In one or more embodiments, the set of sensors (126) may be operably connected to the vehicle device (124).

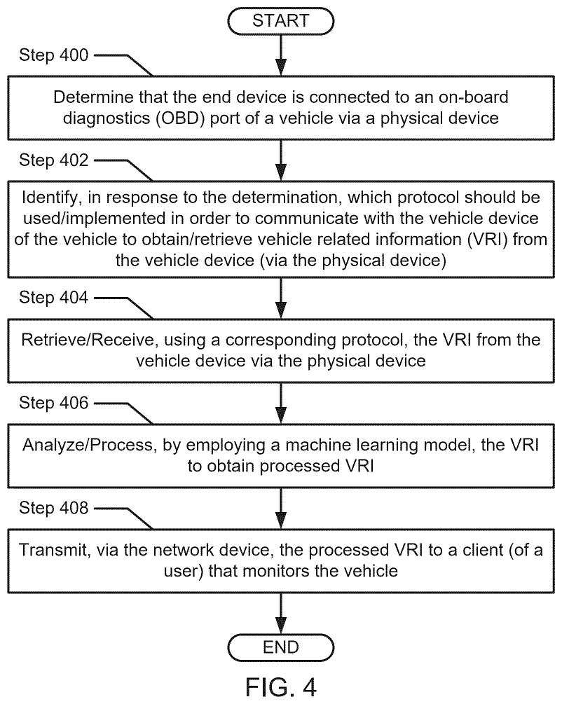

In one or more embodiments, the vehicle device (124) may be a physical or a logical computing device (such as an electronic control unit/module) configured for hosting one or more workloads, or for providing a computing environment whereon workloads may be implemented. In one or more embodiments, the vehicle device (124) may, for example (but not limited to): manage one or more other components of the vehicle (120), store vehicle related information (e.g., the VIN, sensor data from the set of sensors (126), information with respect to speed of the vehicle (120), the fuel level of the vehicle (120), information with respect to engine diagnostics (e.g., engine revolutions, vehicle fault codes, etc.), information with respect to fuel efficiency/usage of the vehicle (120), behavioral information with respect to an operator/driver who is using the vehicle (120), information with respect to powertrain (e.g., engine, transmission, etc.) of the vehicle (120), information with respect to emission control systems of the vehicle (120), a calibration identification number of the vehicle (120), information with respect to an ignition counter of the vehicle (120), a geographic location of the vehicle (120), information with respect to a trip distance/time, information with respect to seat belt usage, information with respect to battery voltage, information with respect to tire pressure, etc.) about the vehicle (120), etc. Further, the vehicle device (124) may be/represent more than one computing device (e.g., 400, FIG. 4) within the vehicle (120), and may not have any control functionality and may be utilized to store information about the vehicle (120).

In one or more embodiments, the end device (122) (e.g., a dash or windshield mounted camera device that is inside or outside of the vehicle (120)) may be a physical or a logical computing device that is operatively coupled/connected to the vehicle device (124) via the physical component (128). In one or more embodiments, referring to FIG. 1.2, the physical component (128) may include two parts/sides: (i) an OBD part (128A) (the “diagnostics part/port”) and (ii) a USB-C part (128B). In one or more embodiments, the end device (122) may be operatively connected to (via its USB-C port) the USB-C part (128B), in which (a) the USB-C part (128B) may be operatively connected to the OBD part (128A) via a cable (that supports electrical USB-C connections) and (b) the OBD part (128A) may be operatively connected to the vehicle device (124) (over an OBD port of the vehicle (120)). Additional details of the OBD part (128A) and the USB-C part (128B) are discussed/illustrated below in reference to FIG. 1.3 and 2.1, respectively.

In one or more embodiments, the end device (122) may communicate with the vehicle device (124) to receive and process information (of the vehicle (120), discussed above). As indicated, the physical component (128) may connect vehicle data interfaces “directly” on/to the end device (122) via electrical USB-C connections (referring to the cable that supports any suitable communication protocol), without the need for any intermediate computing device and/or PCB (e.g., to determine which protocol should be implemented, to perform/provide signal conditioning, signal translation, data processing, and power protection and management capabilities, etc.).

In one or more embodiments, as being a telematics device, the end device (122) may have the functionality to obtain (e.g., from the vehicle device (124) via the physical component (128), via its sensors, etc.) and act upon (e.g., process, analyze, etc.) a vast amount of vehicle related information in real-time (e.g., on the order of milliseconds or less), in addition to a set of vehicle tracking features (e.g., in order to learn more about a related operator's driving habits). For example, the end device (122) may include one or more sensors (e.g., 144, FIG. 1.2) that are operable to collect data representative of the movement of the vehicle (120) including speed and acceleration along with a direction of the movement. In this example, the sensors (included within the end device (122) may include speedometers, accelerometers, gyroscopes, magnetometers, geolocation devices (e.g., a sensor that provides global positions (i.e., latitude and longitude coordinates) using any of the global navigation satellite systems, including the global positioning system (GPS), the global navigation satellite system (GLONASS), the Indian regional navigation satellite system (IRNSS), the quasi-zenith satellite system (QZSS), etc.), or any other type of sensor operable to measure movement.

In one or more embodiments, the clients (e.g., 110A, 110N, etc.) (or the client devices) may be physical or logical computing devices. Such computing devices may be referred to as “endpoints”. In one or more embodiments, an endpoint may be any computing device, collection of computing devices, portion of one or more computing devices, or any other logical grouping of computing resources. In one or more embodiments, the clients (e.g., 110A, 110N, etc.) may collectively be referred to as a client environment (e.g., of a user/customer/organization). In one or more embodiments, the clients (e.g., 110A, 110N, etc.) may represent one or more computing devices hosting a database (e.g., the product information catalog vehicle listing (vPIC) database), generated and maintained by the National Highway Traffic Safety Administration (NHTSA), that includes information about vehicles (e.g., 120) based on a VIN associated with the vehicle.

Further, in one or more embodiments, the clients (e.g., 110A, 110N, etc.) may be computing devices that collect information from any component of the vehicle (e.g., from one or more end devices (e.g., 122) of the vehicle (120)). Doing so may enable a related organization to monitor multiple vehicles from a single computing device.

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users (or users'vehicles) to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., service level agreements (SLAs)) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the vehicle device (124), the end device (122), etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical component including circuitry. The physical component may be, for example (but not limited to): a field-programmable gate array (FPGA), an application-specific integrated circuit, a programmable processor, a microcontroller, a digital signal processor, etc. The physical component may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the end device, the vehicle device, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the end device through any number and type of wired and/or wireless network protocols (e.g., TCP, UDP, IPv4, IPv6, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (or near real-time) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

In one or more embodiments, a computing device is any device, portion of a device, or any set of devices capable of electronically processing instructions and may include, but is not limited to, any of the following: one or more processors (e.g., components that include integrated circuitry) (not shown), memory (e.g., RAM) (not shown), input and output device(s) (not shown), non-volatile storage hardware (e.g., SSDs, HDDs (not shown)), one or more physical interfaces (e.g., network ports, storage ports) (not shown), any number of other hardware components (not shown) and/or any combination thereof.

Examples of a computing device may include, but not limited to, a server (e.g., a blade-server in a blade-server chassis, a rack server in a rack, etc.), a desktop computer, a mobile device (e.g., laptop computer, smart phone, personal digital assistant, tablet computer and/or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a VM, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device. Other types of computing devices may be used without departing from the scope of the embodiments disclosed herein.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, a database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, a computing device may include and/or may be operatively connected to any number of storage volumes (not shown). In one or more embodiments, a volume may be a logically accessible storage element of a computing system. A volume may be part of one or more disk drives and may or may not include any number of partitions. In one or more embodiments, a volume may store information relevant to the operation and/or accessible data of a computing device. In one or more embodiments, a volume may be all or part of any type of computing device storage (described above).

In one or more embodiments, any non-volatile storage (not shown) and/or memory (not shown) of a computing device or system of computing devices may be considered, in whole or in part, as non-transitory computer readable mediums storing software and/or firmware. Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

While FIG. 1.1 shows a configuration of components, other system configurations may be used without departing from the scope of the embodiments disclosed herein.

Turning now to FIG. 1.2, FIG. 1.2 shows a diagram of the vehicle (120) in accordance with one or more embodiments disclosed herein. As indicated, the physical/hardware component (128) may include the OBD part (128A) and the USB-C part (128B). In one or more embodiments, the end device (122) may be operatively connected to (via its USB-C port) the USB-C part (128B), in which (a) the USB-C part (128B) may be operatively connected to the OBD part (128A) via a cable (see FIG. 1.3 and 2.1) and (b) the OBD part (128A) may be operatively connected to the vehicle device (e.g., 124, FIG. 1.1). In one or more embodiments, the end device (122) includes/hosts a network device (140), a database (142), one or more sensors (144), and a manager (146). The end device (122) may include additional, fewer, and/or different components without departing from the scope of the embodiments disclosed herein. Each component may be operably/operatively connected to any of the other components via any combination of wired and/or wireless connections. Each component (of the end device (122)) illustrated in FIG. 1.2 is discussed below.

In one or more embodiments, the network device (140) may include functionality to communicate with other devices (e.g., the vehicle device (e.g., 124, FIG. 1.1), a client (e.g., 110A, FIG. 1.1), etc.) to send and/or receive information to/from end device (122). In one or more embodiments, the network device (140) may be operable to communicate via wired (via the physical component (128)), wireless, or a combination of wired and wireless connections/networks to send and receive information (e.g., from the vehicle device).

For example, the network device (140) may communicate with the vehicle device (e.g., 124, FIG. 1.1), via the physical component (128), to receive a VIN associated with the vehicle (120). Based on the VIN, the network device (202) may communicate with another device that hosts a product information catalog and vehicle listing (vPIC) database (e.g., via a vPIC application programming interface (API)) or any other database that contains information about the vehicle (120) to request and receive additional information about the vehicle associated with the VIN. As yet another example, the network device (140) may send/provide information stored in the database (142) and/or stream data collected by the sensors (144) (e.g., in real-time or periodically) to a client (e.g., 110A, FIG. 1.1).

One of ordinary skill will appreciate that the network device (140) may perform other functionalities without departing from the scope of the embodiments disclosed herein. The network device (140) may be implemented as a computing device using hardware (e.g., any number of integrated circuits for processing computer readable instructions), software (e.g., a computer program), or any combination thereof.

In one or more embodiments, the database (142) may be operable to store (temporarily or permanently) unstructured and/or structured data that includes (or specifies), for example (but not limited to): details of events detected by the manager (146) (described below), data collected by the sensors (144), sets of event detection parameters, VINs, information (e.g., vehicle related information, controller area network (CAN) bus data, etc.) received by the network device (140), information associated with a vPIC database, etc. In embodiments in which the database (142) stores the information associated with the vPIC database, the manager (146) may utilize that information and may not utilize the network device (140) (and, indirectly, the physical component (128)) to retrieve vehicle related information from another device (e.g., 124, FIG. 1.1).

In one or more embodiments, the database (142) may be a fully managed, local, and lightweight database (or any logical container such as an SQLite database) that acts as a shared storage and/or memory resource that is functional to store unstructured and/or structured data. The database (142) may also occupy a portion of a physical storage/memory device or, alternatively, may span across multiple physical storage/memory devices.

In one or more embodiments, the database (142) may be implemented using physical devices that provide data storage services (e.g., storing data and providing copies of previously stored data). The devices that provide data storage services may include hardware devices and/or logical devices. For example, the database (142) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (142) may include a memory device (e.g., a dual in-line memory device), in which data is stored and from which copies of previously stored data are provided. As yet another example, the database (142) may include a persistent storage device (e.g., an SSD), in which data is stored and from which copies of previously stored data is provided. As yet another example, the database (142) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (142) may also be implemented using logical storage. Logical storage (e.g., a virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the sensors (144) may include any number of sensors and any number of each type of sensor described herein. A sensor of the sensors (144) may be operable to collect data representative of, for example, the movement of the vehicle (120), including speed and acceleration along with a direction of movement of the vehicle. For example, the sensor may include speedometers, accelerometers, gyroscopes, magnetometers, geolocation devices, or any other type of sensor operable to measure movement. In this example, an accelerometer may be operable to provide acceleration data and may be operable to detect acceleration along any number of axes, including one axis, two axes, three axes, or more axes.

In one or more embodiments, as being the “brain” of the end device (122), the manager (146) may employ/use a set of linear, non-linear, and/or machine learning (ML) models (e.g., a set of large language models (LLM) that is trained (and/or fine-tuned) on a vast dataset of vehicle related information) to, at least: (i) determine which protocol should be implemented (e.g., in order to communicate with the vehicle device (e.g., 124, FIG. 1.1) over the physical component (128)) without having prior knowledge of its installation environment (e.g., without requiring preinstallation information with respect to the vehicle (120), (ii) perform/provide signal conditioning, signal translation, data processing, and power protection and management capabilities (e.g., to determine fuel consumption over a trip, to determine start and finish times of the trip, to determine a period of time that the vehicle's engine was idle, etc.), (iii) similar to the physical component (128), operate/provide its functionalities without having prior knowledge of its installation environment (e.g., without requiring preinstallation information with respect to the vehicle (120); (iv) set one or more thresholds to determine which event(s) (e.g., loss of GPS, low power source, overdue vehicle maintenance, etc.) should be stored to the database (142) and/or sent to another device (e.g., 110A, FIG. 1.1) via the network device (140) or the physical component (128); and/or (v) receive/collect information (e.g., vehicle related information, CAN bus data, etc.) from the vehicle device (e.g., 124, FIG. 1.1) (via the network device (140) and/or the physical component (128)) without requiring any intermediate computing device and/or PCB (e.g., directly from an OBD port of the vehicle (120) to the end device (122) using only the physical component (128), in which, for example, the entire engine diagnostics data is delivered over USB-C channels/connections (e.g., CAN buses over the cable that operates based on message-based CAN communication protocols) to the end device for processing and/or storage).

One of ordinary skill will appreciate that the manager (146) may perform other functionalities without departing from the scope of the embodiments disclosed herein. The manager (146) may be implemented as a computing device using hardware (e.g., any number of integrated circuits for processing computer readable instructions), software (e.g., a computer program), or any combination thereof.

In one or more embodiments, to provide the end device's (122) functionalities, the network device (140), the database (142), the sensors (144), and the manager (146) may be hosted/located on a single PCB inside the end device (122), which further includes/supports any suitable interface (e.g., a USB-C port, one or more data/CAN buses (operable to transmit communication between various hardware components of the end device), one or more peripheral component interconnect express (PCIe) buses, one or more J1708 data buses, etc.) that is integrated within the USB-C channels (e.g., the cable), along with the electrical lines/channels.

Turning now to FIG. 1.3, FIG. 1.3 shows a first isometric view of the OBD side (of the physical component) in accordance with one or more embodiments disclosed herein. In one or more embodiments, the OBD side (or the OBD-II side) (128A) of the physical component (e.g., 128, FIG. 1.2) includes two parts: (i) the first part (the “male” part) and (ii) the second part (the “female” part). In one or more embodiments, the first part may be easily and safely plugged into (or coupled/connected to) the OBD port of the vehicle (e.g., 120, FIG. 1.2), and the second part may be used as a pass through, if another device is needed to be connected to the OBD side (128A).

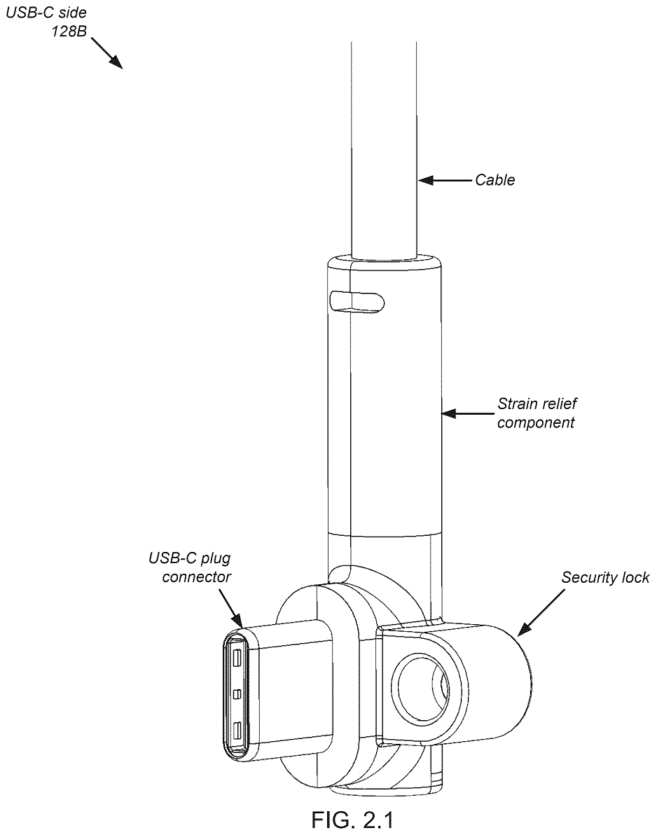

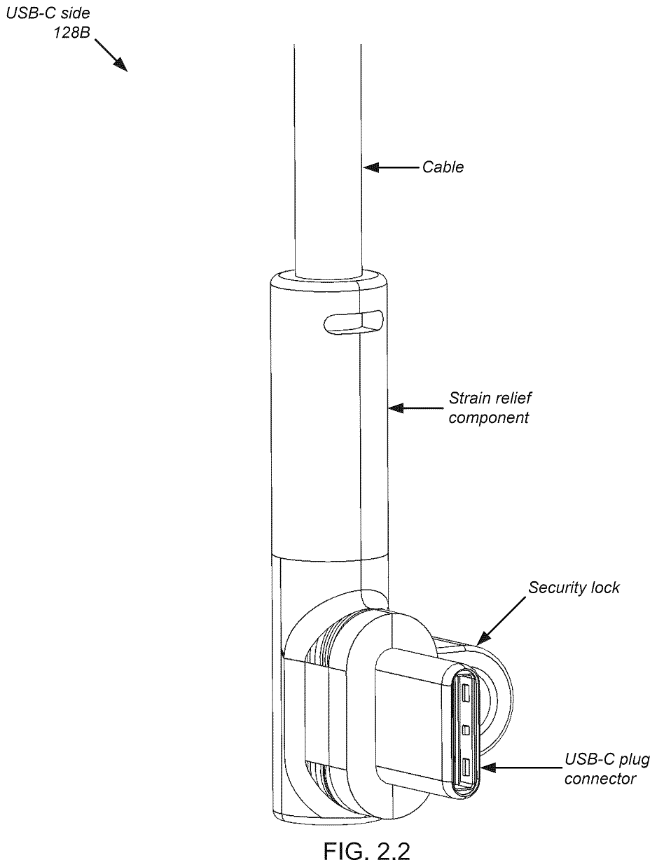

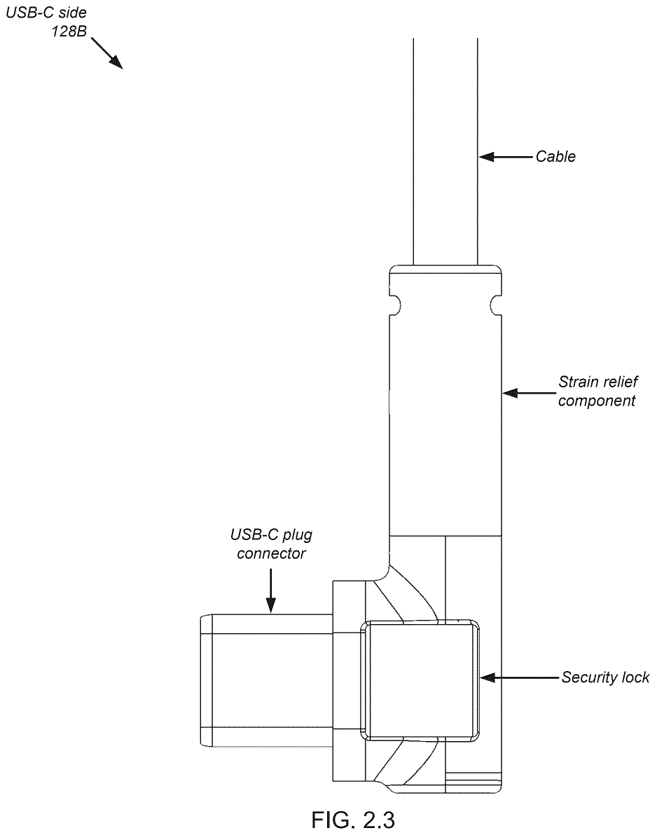

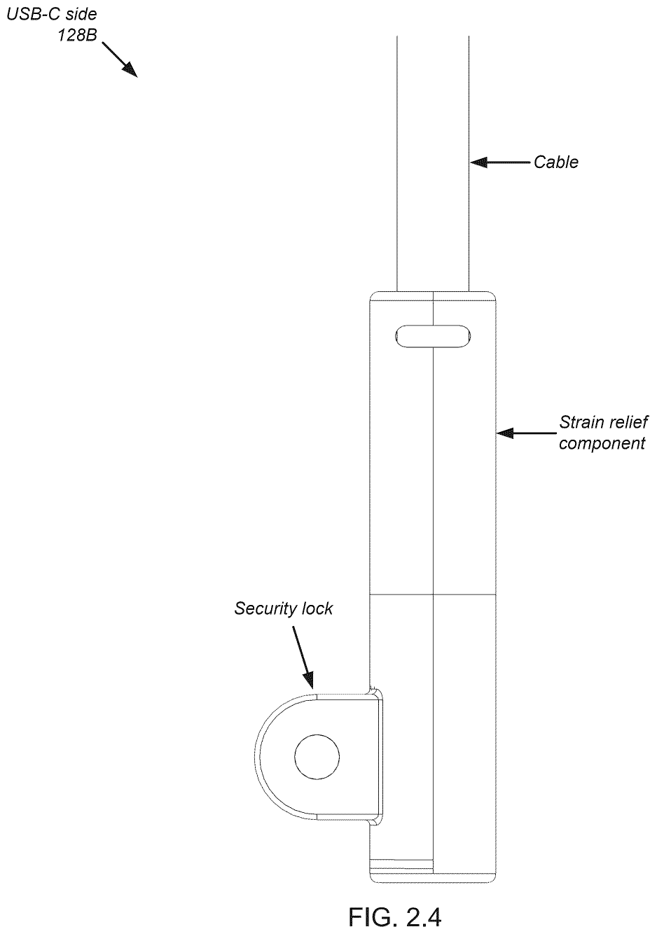

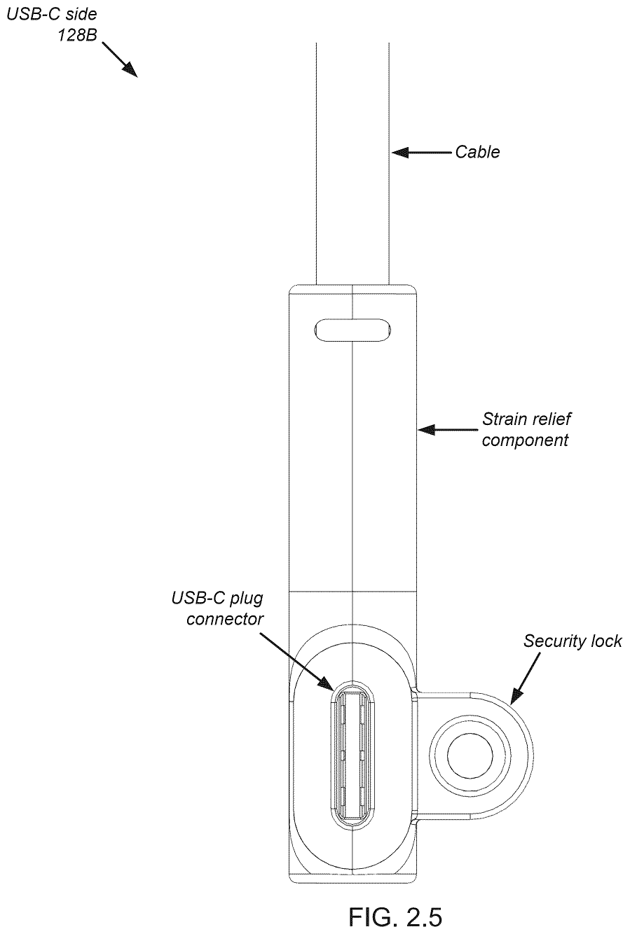

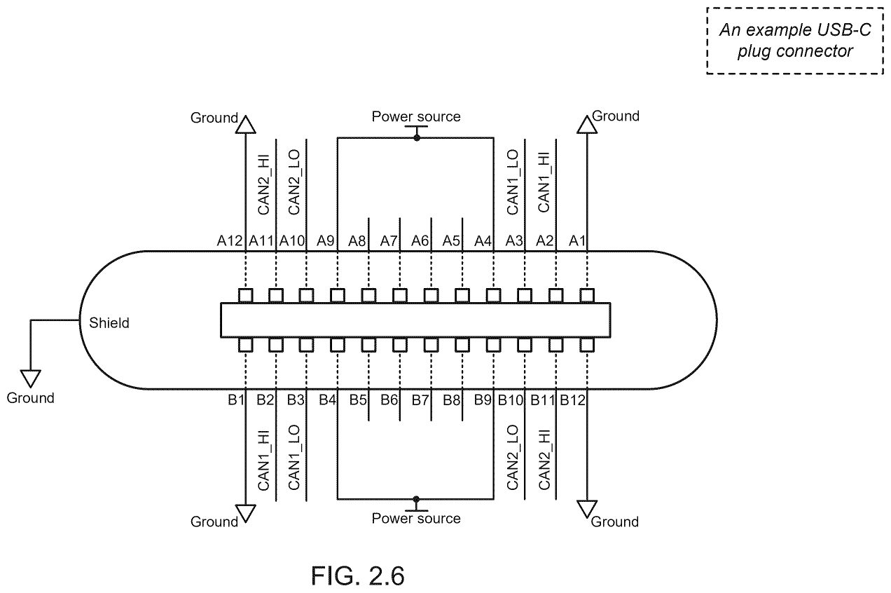

As discussed above, the OBD part (128A) may be operatively connected to the USB-C part (e.g., 128B, FIG. 2.1) via a cable (e.g., a direct USB-C cable that supports electrical USB-C connections/channels, CAN buses, VDI buses, etc.) to transmit/deliver, for example, vehicle related information/data and power to the end device (e.g., 122, FIG. 1.2) so that the components of the end device can perform their functionalities. In one or more embodiments, the OBD side of the cable may include a strain relief component.

As used herein, a “cable” includes any cable, conduit, or line that carries one or more conductors and that is flexible over at least a portion of its length. A cable may include a connector portion, such as a plug, at one or more of its ends.

Turning now to FIG. 1.4, FIG. 1.4 shows a second isometric view of the OBD side/part (of the physical component) in accordance with one or more embodiments disclosed herein.

Turning now to FIG. 1.5, FIG. 1.5 shows a third isometric view of the OBD part (of the physical component) in accordance with one or more embodiments disclosed herein.

Turning now to FIG. 1.6, FIG. 1.6 shows a fourth isometric view of the OBD part (of the physical component) in accordance with one or more embodiments disclosed herein.

Turning now to FIG. 1.7, FIG. 1.7 shows a fifth isometric view of the OBD part (of the physical component) in accordance with one or more embodiments disclosed herein.

Turning now to FIG. 1.8, FIG. 1.8 shows a sixth isometric view of the OBD part (of the physical component) in accordance with one or more embodiments disclosed herein.

Turning now to FIG. 1.9, FIG. 1.9 shows a first side view of the OBD part (of the physical component) in accordance with one or more embodiments disclosed herein.

Turning now to FIG. 1.10, FIG. 1.10 shows a top view of the OBD part (of the physical component) in accordance with one or more embodiments disclosed herein.

Turning now to FIG. 1.11, FIG. 1.11 shows a second side view of the OBD part (of the physical component) in accordance with one or more embodiments disclosed herein.

Turning now to FIG. 1.12, FIG. 1.12 shows a third side view of the OBD part (of the physical component) in accordance with one or more embodiments disclosed herein.

Turning now to FIG. 2.1, FIG. 2.1 shows a first isometric view of the USB-C part of the physical component in accordance with one or more embodiments disclosed herein. In one or more embodiments, the USB-C side (128B) of the physical component (e.g., 128, FIG. 1.2) includes a USB-C plug connector and a security lock. In one or more embodiments, the USB-C plug connector may be easily and safely plugged into (or coupled/connected to) the USB-C port of the end device (e.g., 122, FIG. 1.2), in which the USB-C plug connector may be affixed/mounted to the single PCB (or a cable interface) inside the end device. After the USB-C plug connector is plugged into the USB-C port, for a more stable, secure connection, standard mechanical mechanisms (e.g., bolts, screws, nuts, studs, etc.) may be used through the security lock. Other mechanical or non-mechanical (e.g., glue, an adhesive tape, etc.) mechanisms for securely affixing the USB-C plug connector to the USB-C port may be used without departing from the scope of the embodiments disclosed herein.

As discussed above, the USB-C part (128B) may be operatively connected to the OBD part (e.g., 128A, FIG. 2.1) via the cable to transmit/deliver, for example, vehicle related information/data and power to the end device (e.g., 122, FIG. 1.2) so that the components of the end device can perform their functionalities. In one or more embodiments, the USB-C side of the cable may also include a strain relief component.

Turning now to FIG. 2.2, FIG. 2.2 shows a second isometric view of the USB-C part of the physical component in accordance with one or more embodiments disclosed herein.

Turning now to FIG. 2.3, FIG. 2.3 shows a side view of the USB-C part of the physical component in accordance with one or more embodiments disclosed herein.

Turning now to FIG. 2.4, FIG. 2.4 shows a rear view of the USB-C part of the physical component in accordance with one or more embodiments disclosed herein.

Turning now to FIG. 2.5, FIG. 2.5 shows a front view of the USB-C part of the physical component in accordance with one or more embodiments disclosed herein.

Turning now to FIG. 2.6, FIG. 2.6 shows a pinout of an example USB-C plug connector of the USB-C part (of the physical component) in accordance with one or more embodiments disclosed herein. The example, illustrated in FIG. 2.6 and described below, is for explanatory purposes only and not intended to limit the scope disclosed herein.

Referring to FIG. 2.6, the example USB-C plug connector includes 24 pins (A1-A12 and B1-B12), in which one or more available alternate mode pins are used to connect to related CAN buses (e.g., so that related pins of the OBD side can be electrically extended through the end device (e.g., 122, FIG. 1.1) in order to receive vehicle related information and process the information) and to receive electrical power from a corresponding power source (e.g., a battery of the vehicle (e.g., 120, FIG. 1.1)) so that the end device can perform its functionalities. Due to its reversibility, the example USB-C plug connector can be connected to the USB port of the end device (e.g., 122, FIG. 1.1) in any direction/orientation (without experiencing any performance related issues).

While the example USB-C plug connector is demonstrated as having/including 24 pins, those skilled in the art will appreciate that the example USB-C plug connector may have/include any number of pins (and/or have any other pin layout) to perform its functionalities without departing from the scope of the embodiments disclosed herein.

In one or more embodiments, the example USB-C plug connector may further include a shield/shroud for protection purposes, in which the shield and the cable (see FIG. 1.3) may be made of any kind of material for the best user experience.

In general, vehicle diagnostic buses (e.g., CAN buses) use a differential signaling scheme to improve noise immunity, which means each bus requires two signal lines such as HIGH/HI (e.g., CAN2_HI) and LOW/LO (e.g., CAN2_LO). Referring to FIG. 2.6, CAN1_HI and CAN1_LO refer to the differential pair of the first bus, while CAN2_HI and CAN2_LO refer to a second data bus. The power source pins (A4, A9, B4, and B9) indicates the electrical power supplied by the vehicle (e.g., 120, FIG. 1.1) to be used by the connected end device (e.g., 122, FIG. 1.1). The ground pins (A1, A12, B1, and B12) indicates the electrical ground of the example USB-C plug connector, which is provided through the chassis of the vehicle (e.g., 120, FIG. 1.1). As indicated, the shield is also connected to the electrical ground (to ensure that all the electrical devices have a commo voltage reference).

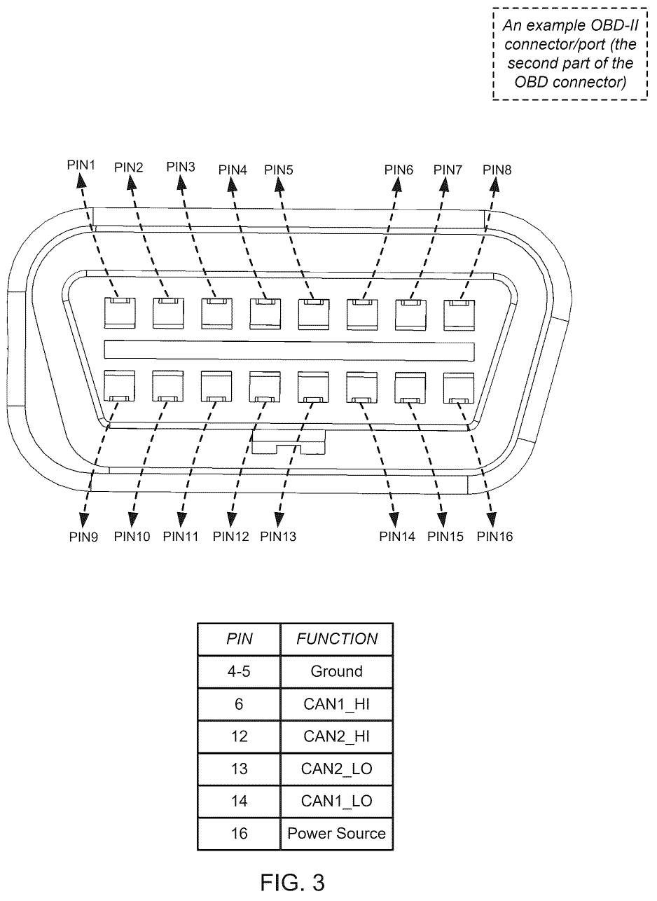

Turning now to FIG. 3, FIG. 3 shows a front view of the OBD connector/part (of the physical component) in accordance with one or more embodiments disclosed herein. The example, illustrated in FIG. 3 and described below, is for explanatory purposes only and not intended to limit the scope disclosed herein.

Referring to FIG. 3, the example second part of the OBD connector includes 16 pins (PIN1-PIN16), in which (i) PINs 4-5 are connected/extended to the ground pins of the example USB-C plug connector (over the cable), (ii) PIN 6 is connected to CAN1_HI pins of the example USB-C plug connector (over the cable), (iii) PIN 12 is connected to CAN2_HI pins of the example USB-C plug connector (over the cable), (iv) PIN 13 is connected to CAN2_LO pins of the example USB-C plug connector (over the cable), (v) PIN 14 is connected to CAN1_LO pins of the example USB-C plug connector (over the cable), (vi) PIN 16 is connected to the power source pins of the example USB-C plug connector (over the cable), and (vii) the remaining pins of the example second part of the OBD connector may be used for any other purpose (e.g., for vendor specific options).

While the example second part of the OBD connector is demonstrated as having/including 16 pins, those skilled in the art will appreciate that the example second part of the OBD connector may have/include any number of pins (and/or have any other pin layout) to perform its functionalities without departing from the scope of the embodiments disclosed herein.

As discussed above, any installations of end devices (e.g., vehicle telematics devices, dash cameras, asset trackers, etc.) requiring installation away from the physical location of the vehicle diagnostic connectors in vehicles (that utilizes access to vehicle related/telematics information that is obtained over VDI buses) would benefit greatly from the framework (of the physical component). The physical component eliminates the need for a second device or PCB holding the associated circuitry used for data processing, signal conditioning, signal translation, signal protection, and/or power management capabilities.

FIG. 4 shows a method for monitoring a vehicle in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 4, the method shown in FIG. 4 may be executed by, for example, the above-discussed manager (e.g., 146, FIG. 1.2). Other components of the system (100) illustrated in FIG. 1.1 may also execute all or part of the method shown in FIG. 4 without departing from the scope of the embodiments disclosed herein.

In Step 400, the manager determines that the end device (e.g., 122, FIG. 1.2) is operatively connected to an OBD port of the vehicle via the physical device/component (e.g., 128, FIG. 1.2). In one or more embodiments, (i) the physical device includes a cable, an OBD part (e.g., 128A, FIG. 1.2), and a USB-C part (e.g., 128B, FIG. 1.2), (ii) the end device is operatively connected to the USB-C part via a USB-C port of the end device, and (iii) the USB-C part is operatively connected to the OBD part via the cable.

In Step 402, in response to the determination, the manager identifies which protocol should be used/implemented in order to communicate with the vehicle device of the vehicle to obtain/retrieve vehicle related information (VRI) from the vehicle device (via the physical device). In one or more embodiments, (i) the protocol is identified without having prior knowledge about an environment that the end device is installed, (ii) the end device is operatively connected to the vehicle device via the physical device without requiring an intermediate computing device or a PCB in between the end device and the vehicle device, and (iii) the OBD part is operatively connected to the vehicle device via an OBD port of the vehicle.

In Step 404, using a corresponding protocol (e.g., the identified protocol), the manager retrieves the VRI from the vehicle device via the physical device. In one or more embodiments, the VRI may include, for example (but not limited to): information with respect to speed of the vehicle, a fuel level of the vehicle, information with respect to engine diagnostics of the vehicle, behavioral information with respect to an operator that uses the vehicle, information with respect to an emission control system of the vehicle, a calibration identification number of the vehicle, information with respect to an ignition counter of the vehicle, a geographic location of the vehicle, etc.

In Step 406, by employing an ML model, the manager processes the VRI to obtain processed VRI. In one or more embodiments, the end device includes only one PCB to retrieve and process the VRI. Further, while processing the VRI to obtain the processed VRI, the ML model may perform, at least, signal conditioning and signal translation on the VRI. In Step 408, via the network device (e.g., 140, FIG. 1.2), the manager transmits the processed VRI to a client (e.g., 110A, FIG. 1.1) of a user that monitors the vehicle. In one or more embodiments, the method may end following Step 408.

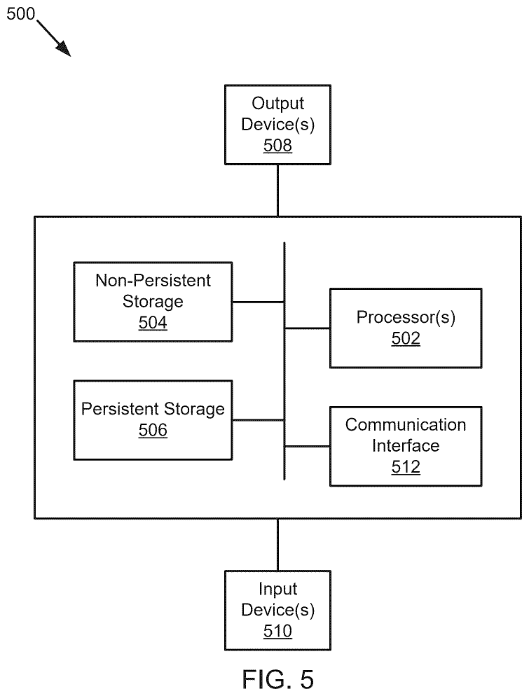

Turning now to FIG. 5, FIG. 5 shows a diagram of a computing device in accordance with one or more embodiments disclosed herein.

In one or more embodiments disclosed herein, the computing device (500) may include one or more computer processors (502), non-persistent storage (504) (e.g., volatile memory, such as RAM, cache memory), persistent storage (506) (e.g., a non-transitory computer readable medium, a hard disk, an optical drive such as a CD drive or a DVD drive, a Flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) (502) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (e.g., a LAN, a WAN, Internet, mobile network, etc.) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

Specific embodiments disclosed herein are described in detail with reference to the accompanying figures. In the above detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the above description of the figures, any component described with regard to a figure, in various embodiments disclosed herein, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein.

What is claimed is:

1. A physical device, comprising:
a cable;
an on-board diagnostics (OBD) part,
wherein the OBD part is operatively connected to a vehicle device of a vehicle via an OBD port of the vehicle; and
a universal serial bus (USB) type C (USB-C) part,
wherein the USB-C part is operatively connected to the OBD part via the cable,
wherein an end device is operatively connected to the USB-C part via a USB-C port of the end device,
wherein the end device is operatively connected to the vehicle device via the physical device to receive and process vehicle related information (VRI) without requiring an intermediate computing device or a printed circuit board (PCB) in between the end device and the vehicle device, and
wherein the end device comprises only one PCB to receive and process the VRI.

2. The physical device of claim 1,
wherein the cable comprises electrical USB-C connections to transmit the VRI from the vehicle device to the end device, and
wherein the cable comprises power connections to transmit electric power from a power source of the vehicle to the end device.

3. The physical device of claim 2,
wherein the electrical USB-C connections are vehicle data information buses that support any suitable communication protocol.

4. The physical device of claim 1,
wherein an OBD side of the cable comprises a first strain relief component, and
wherein a USB-C side of the cable comprises a second strain relief.

5. The physical device of claim 1,
wherein the end device is located inside or outside of the vehicle, and
wherein the vehicle is associated with a unique identifier.

6. The physical device of claim 5,
wherein a movement of the vehicle is managed by an operator,
wherein the vehicle comprises a set of sensors, and
wherein the vehicle device receives data from the set of sensors and generates the VRI from the data.

7. The physical device of claim 1,
wherein the end device is a telematics device that is adapted to obtain optical information regarding an environment, and
wherein the end device receives and processes the VRI without requiring any prior knowledge about the vehicle.

8. The physical device of claim 1,
wherein, to receive and process the VRI, the end device comprises a manager,
wherein, to process the VRI, the manager uses a machine learning (ML) model,
wherein the ML model is a large language model that is trained and fine-tuned on a vast amount of VRI that is obtained from a second vehicle and a third vehicle.

9. The physical device of claim 1, wherein the physical device operates without requiring any prior knowledge about an environment that the physical device is installed.

10. The physical device of claim 1, wherein the VRI comprises information with respect to speed of the vehicle, a fuel level of the vehicle, information with respect to engine diagnostics of the vehicle, behavioral information with respect to an operator that uses the vehicle, information with respect to an emission control system of the vehicle, a calibration identification number of the vehicle, information with respect to an ignition counter of the vehicle, and a geographic location of the vehicle.

11. The physical device of claim 1,
wherein the OBD part comprises a first part and a second part,
wherein the first part is operatively connected to the OBD port of the vehicle, and
wherein the second part would be used as a pass through when another device is needed to be operatively connected to the OBD part.

12. The physical device of claim 1,
wherein the USB-C part comprises a USB-C plug connector and a security lock,
wherein the USB-C plug connector is operatively connected to the USB-C port in any orientation, and
wherein the USB-C plug connector is affixed to the only one PCB via the security lock.

13. The physical device of claim 12, wherein the USB-C plug connector comprises a set of pins that corresponds to a second set of pins of the OBD part.

14. A method for monitoring a vehicle, the method comprising:
determining that an end device is operatively connected to an on-board diagnostics (OBD) port of the vehicle via a physical device,
wherein the physical device comprises a cable, an OBD part, and a universal serial bus (USB) type C (USB-C) part,
wherein the end device is operatively connected to the USB-C part via a USB-C port of the end device,
wherein the USB-C part is operatively connected to the OBD part via the cable;
identifying, in response to the determining, a protocol that needs to be implemented in order to communicate with a vehicle device of the vehicle to obtain vehicle related information (VRI) from the vehicle device via the physical device,
wherein the protocol is identified without having prior knowledge about an environment that the end device is installed,
wherein the end device is operatively connected to the vehicle device via the physical device without requiring an intermediate computing device or a printed circuit board (PCB) in between the end device and the vehicle device,
wherein the OBD part is operatively connected to the vehicle device via an OBD port of the vehicle;
retrieving, using the protocol, the VRI from the vehicle device via the physical device;
processing, by employing a machine learning (ML) model, the VRI to obtain processed VRI,
wherein the end device comprises only one PCB to retrieve and process the VRI; and
transmitting, via a network device of the end device, the processed VRI to a client of a user that monitors the vehicle.

15. The method of claim 14, wherein while processing the VRI to obtain the processed VRI, the ML model performs signal conditioning and signal translation on the VRI.

16. The method of claim 14,
wherein the cable comprises electrical USB-C connections to transmit the vehicle related information from the vehicle device to the end device,
wherein the cable comprises power connections to transmit electric power from a power source of the vehicle to the end device,
wherein an OBD side of the cable comprises a first strain relief component, and
wherein a USB-C side of the cable comprises a second strain relief.

17. The method of claim 14,
wherein the end device is located inside or outside of the vehicle,
wherein the vehicle is associated with a unique identifier,
wherein a movement of the vehicle is managed by an operator,
wherein the vehicle comprises a set of sensors, and
wherein the vehicle device receives data from the set of sensors and generates the VRI from the data.

18. The method of claim 14,
wherein the end device is a telematics device that is adapted to obtain optical information regarding the environment, and
wherein the end device retrieves and processes the VRI without requiring any prior knowledge about the vehicle.

19. The method of claim 14, wherein the VRI comprises information with respect to speed of the vehicle, a fuel level of the vehicle, information with respect to engine diagnostics of the vehicle, behavioral information with respect to an operator that uses the vehicle, information with respect to an emission control system of the vehicle, a calibration identification number of the vehicle, information with respect to an ignition counter of the vehicle, and a geographic location of the vehicle.

20. The method of claim 14,
wherein the USB-C part comprises a USB-C plug connector and a security lock,
wherein the USB-C plug connector is operatively connected to the USB-C port in any orientation, and
wherein the USB-C plug connector is affixed to the only one PCB via the security lock.
